(19) United States
(12) Patent Application Publication
(10) Pub. No.: US 2014/0058814 A1
(43) Pub. Date: Feb. 27, 2014

(54) SYSTEM AND METHOD FOR DISTRIBUTION AND SALE OF DIGITAL CONTENT

(71) Applicant: Robert Hayden, Wahroonga (AU)

(72) Inventor: Robert Hayden, Wahroonga (AU)

(21) Appl. No.: 14/010,513

(22) Filed: Aug. 26, 2013

Related U.S. Application Data
(60) Provisional application No. 61/693,280, filed on Aug. 25, 2012.

(51) Int. Cl. G06Q 30/02

(52) U.S. Cl. CPC G06Q 30/0214
USPC 705/14.16

(57) ABSTRACT

A system and method for distribution of digital content and goods includes means for rewarding multiple levels of participants involved in the recommendation/sales process. Distribution may be direct through platform-generated commerce and/or indirect through recommendations on external social media sites, communications platforms, blogs and other social and commerce sites. Multiple levels of users of the system may be compensated for participating in sales of content based on their activity and hierarchy within user networks related to the sale.

### RELATED APPLICATIONS

This application claims benefit of priority to U.S. provisional application Ser. No. 61/693,280 titled “Systems and Methods for Distribution of Digital Content” filed on Aug. 25, 2012 by inventor Robert Hayden which application is hereby incorporated by reference as though fully and completely set forth herein.

### TECHNICAL FIELD

The disclosed embodiments relate generally to computer systems and methods, and in particular to systems and methods for distributing digital content within social networks.

### BACKGROUND

Unless otherwise indicated herein, the approaches described in this section are not prior art to the claims in this application and are not admitted to be prior art by inclusion in this section.

Online commerce and content/goods distribution sites are known, and some include affiliate sales programs to reward customers for recommending or reselling their goods. Such programs are often reliant on the customer setting up an online store to resell the goods and attract new customers to that store so they can earn a percentage of each resultant sale. They are rewarded only for the direct sales that result.

Existing sites for distributing digital content tend to primarily benefit either the artist or creator of the content (e.g., the seller) or the fan/consumer, but not both. Still other commerce sites simply act as a marketplace for content and goods, but at a high price to the seller, e.g., due to hosting fees or other third party fees.

There remains a need for an improved system and method for distributing content, and in particular a system and method that optimizes amounts received by a seller, rewards a customer for influencing a subsequent sale, and also rewards for the sales that those new customers influence, and so on to multiple levels within a network.

### SUMMARY

Embodiments of the present invention improve digital commerce by providing a system and method for distribution of digital content and goods using social networks, including means for rewarding multiple levels of participants involved in the recommendation and sales process.

In some embodiments of the present invention, a system referred to as Monkeybars is an Internet and mobile technology platform for distributing digital content and goods. Distribution may be direct through platform-generated commerce and/or indirect through recommendations, for example on external social media sites, communications platforms, blogs and other social and commerce sites. In some embodiments.

In some embodiments, an object of a social commerce platform for distribution and sale of digital content, including books, film and music is to reward the content owner (including, for example, content authors and/or publishers, filmmakers and artists), and also to reward the consumer. For example, in one embodiment of the system a non-exclusive online marketplace for artists utilizes social networking tools to promote the artists' content to increase sales and create new revenue streams.

### BRIEF DESCRIPTION OF THE DRAWINGS

For a better understanding of the nature and objects of the invention, reference should be made to the following detailed description taken in conjunction with the accompanying drawings, in which:

FIG. 1 is a schematic illustration of a system and method 10 for distribution and sale of digital content according to an embodiment of the present invention.

FIG. 2 is a schematic illustration of a system architecture 300 of a social commerce platform comprising distributed server systems for managing and distributing digital content.

FIG. 3 is a flow chart of a method 300 for registering a new user and assigning inviter values to create a member/user hierarchy according to one embodiment of the present invention.

FIG. 4 is a schematic illustration of a method 400 for managing, marketing and distributing digital content over social networks according to one embodiment of the present invention.

FIG. 5 is an exemplary screen shot 500 illustrating a user interface of a system according to the present invention.

FIG. 6 is a flow chart of a method 600 for providing a reward to a purchaser of digital content for recommending that content to friends according to one embodiment of the present invention.

FIG. 7 is a conceptual flow diagram of a method 700 for distributing digital content according to the present invention, showing a hierarchy of system users, including subscribers, free users and visitors.

FIGS. 8A-F are schematic illustrations showing steps 802, 804, 806, 808, 810 and 812 of an exemplary method of using the system of the present invention to distribute content and reward users in a hierarchy of users.

Like reference numerals refer to the same or similar components throughout the several views of the drawings.

### DESCRIPTION OF EMBODIMENTS

Described herein is a social commerce platform, and a system and method for distribution and sale of digital content, including books, film and music. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

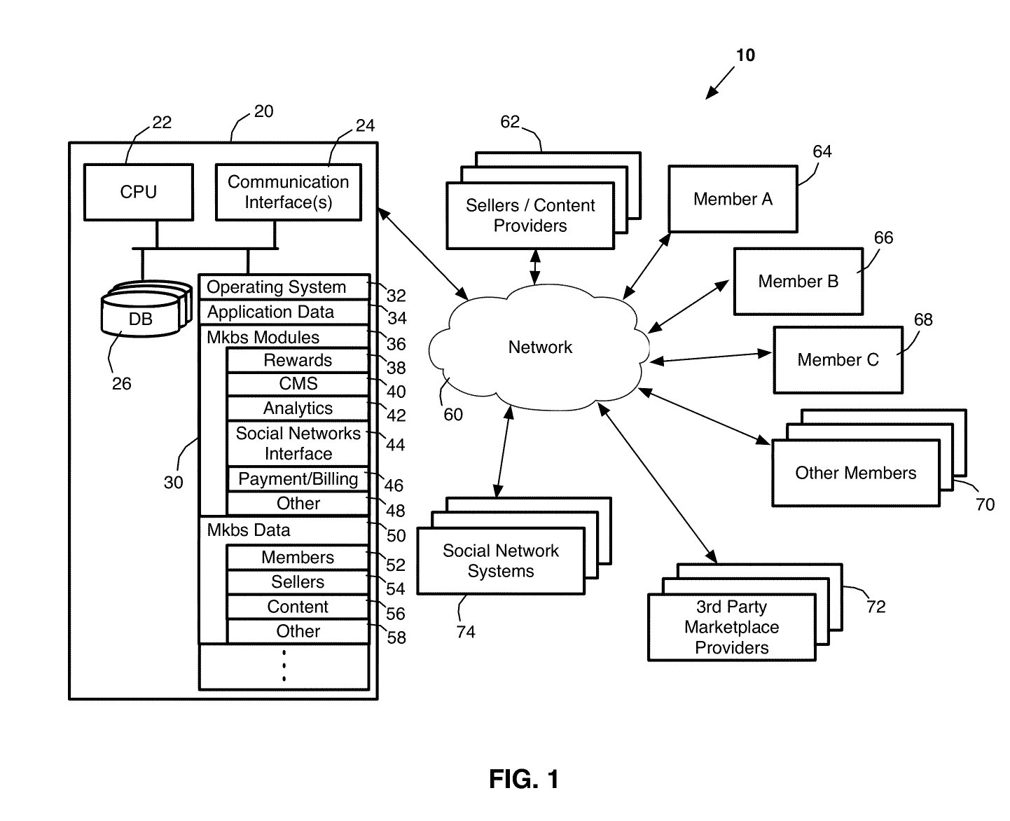

Referring to FIG. 1, in some embodiments of the present invention, a system for distribution and sale of digital content 10 may include a social commerce platform 20 (referred to herein as “Monkeybars”) communicating over a network 60 with content providers 62, a plurality of members or users 64, 66, 68, 70. Users may include various types of members, subscribers, visitors, and other users depending, e.g., upon level of participating in the system. Platform 20 is also configured to communicate with, and/or facilitation communications and transactions over, social network systems 74 and, in some embodiments, third party content providers or distributors of content 72. In some embodiments, sellers are artists or other creators or content, which may include books, film and music. Sales are facilitated by users of the system 64 66, 68, 70, e.g., via their communications over social networks 74, and the users are rewarded based upon their level of participation in the system and relationship to the purchaser of the content, e.g., via direct and indirect recommendations. The modules 36 may include instructions for administering rewards 38, managing content 40, performing analytics, 42, interfacing with social networks 44, processing payments 46, and other processes 48. Data stored in the system (which may include storage in distributed servers or the a cloud system), may include data related to members 52, sellers or content providers 54, content 56, or other data that may be used by the system 58.

System 20 may be server-based as shown in FIG. 1, or may comprise multiple computers or cloud-based services. In an exemplary embodiment, system 20 includes at least one processor or central processing unit (CPU) 22, and at least one communication or network interface 24 for communicating with other computers or systems over a network 60, one or more databases 26, and a memory 30 comprising a number of functional modules. Memory 30 may include high-speed random access memory (RAM) and/or non-volatile memory, such as one or more magnetic disc storage devices. Memory 30 may store an operating system (or set of instructions) 32, such as LINUX, UNIX, MAC OS, or WINDOWS, that includes procedures for handling basic system services and for performing hardware independent tasks. Memory 30 may also store information, procedures or instructions such as application data 34, application-specific Monkeybars modules 36, and application-specific Monkeybars data 50.

The platform may also be used for distribution and sale of goods and services. Other content distribution sites tend to primarily benefit either the Artist (seller) or the fan (consumer), but not both, and there are still other commerce sites that simply act as an effective marketplace for content and goods but at a high price to the seller. An advantage of the present invention is to benefit both the seller (e.g., artist) and the consumer (e.g., fan) without necessarily charging a large fee or percentage of sale.

In one embodiment, the Monkeybars system integrates social networking capabilities with a commerce experience that rewards consumption and subsequent recommendation of digital content across all major social networks through a feature referred to herein as the Social Graph Royalty Program (“SGRP”). Rather than charging a distribution fee or a download transaction fee, the SGRP allows the legal owners of items of content or goods to assign a portion of the sales price to the rewards program. The assigned portion can subsequently be awarded to members for performing certain actions, such as recommending the item to their friends or building the content owners network/audience. In some embodiments a platform utilizes a freemium model (e.g., free to join), and may include a subscription plan for additional features and increased rewards.

In some embodiments, Monkeybars is a membership-based model. Each new member is established in a genealogy, or hierarchy, that describes their position on the site relative to other members. The position within the genealogy structure may be based primarily on a member's relationship to another member, e.g., based on invitations to join or recommendations to buy an item on the platform. A member's position within the genealogy can then be referenced for the purposes of allocating rewards for recommendations to purchase items. For example, if a member (B) is invited to join the platform by another existing member (A), member B will become part of member A's network and will be placed within the genealogy structure under member A. This position describes the relationship such that it is known that member B is a part of Monkeybars as a result of member A's invitation.

Monkeybars may include a number of ways for members to search, discover and be presented with items for sale, or being promoted, and also provides for a number of ways to allow promotion and recommendation of items for sale through external sites, platforms and mobile applications.

Content owners/sellers (also referred to as merchants) may remain in control of the rights to their items and can set and adjust their prices and reward levels as they please. The items of digital content may include a security component that allows the platform to keep track of where it goes (like a digital fingerprint) which provides extra security against illegal distribution of the digital content. In some embodiments, this may be as a do-it-yourself platform for promotion and distribution (including sale) of digital content, goods and services.

In some embodiments, Monkeybars allows for sale by digital download, rental, streaming or free distribution. Goods and services may also be promoted and distributed through SGRP or MRP (Monkeybars). SGRP/MRP supports bundling of different formats and file types into one item so that a customer/fan can purchase multiple digital goods in a single purchase (for example they might buy a film but received the e-book and soundtrack to accompany the film in a single transaction).

In some embodiments, MRP/SGRP allocates rewards (based on genealogy relative to invitations or to a recommendation to buy) across multiple degrees of influence (or separation) and therefore takes advantage of the connected nature of social networks to help increase viral distribution of an item. It is possible to allocate rewards and extend the genealogy structure indefinitely, but some embodiments entail tracking the effect (commerce or new members) of member actions to five degree of influence away from them and subsequently providing for a means to reward a member for the influence they have had over their resultant network. For example a member could earn a reward from a purchase that resulted from their initial recommendation by a friend of a friend of a friend of a friend of a friend, and so on, provided the purchase resulted from a recommendation that remained within the rules of the reward program (including, for example, the provision that everyone acting on the recommendation or invitation must join the platform first).

While other commerce and content/goods distribution sites may offer affiliate sales programs to reward customers for recommending or reselling their goods, these programs are often reliant on the customer setting up an online store to resell the goods and attracting new customers to that store so they can earn a percentage of each resultant sale. They are rewarded only for the direct sales that result. In contrast, Monkeybars not only rewards a customer for influencing a subsequent sale but rewards for the sales that those new customers influence and so on, e.g., to five levels of separation.

Making a recommendation (which may lead to a reward being earned) related to an item of content may be easily performed directly from Monkeybars onto a number of popular social networks and other communication platforms. For example, a member can simply choose where they would like to share their recommendation and Monkeybars inserts it, along with a personalized message and information about the item, directly onto the member's choice of social networking platform (in some cases, only if they have a membership to that platform). Such embodiments enable members to be rewarded for their influence across their existing networks without significantly changing their behavior.

In some embodiments, Monkeybars also allows for communication between members and between content owners (e.g., merchants, such as artists, authors, filmmakers, etc.) and their audience (e.g., fans, followers, customers, etc). Analytics may provide additional ways for content owners to understand the behavior and buying patterns of the audience and to communicate with them subsequent to a purchase or action that resulted in a previous connection. Members who purchase or connect with digital content or goods may be connected to the item they purchased so that the owner/seller of the item has a record and a means to re-message anyone who has interacted with their item. This may be a powerful tool for content owners/sellers to market back to previous customers and fans. Customers/fans can also use the platforms tools to purchase items on behalf of someone else and send them as a gift through email or social networks, etc.

Monkeybars may store member's digital content (uploaded or purchased) in the cloud and subsequently allow for streaming of the content back to a device or a computer. Content can also be downloaded directly to a device or computer. The ability to store the content in the cloud means that it can easily be retrieved from any compatible connected device or computer. The platform also allows for the setting of permissions and privacy levels to control how the content is distributed or consumed (streamed or downloaded etc.).

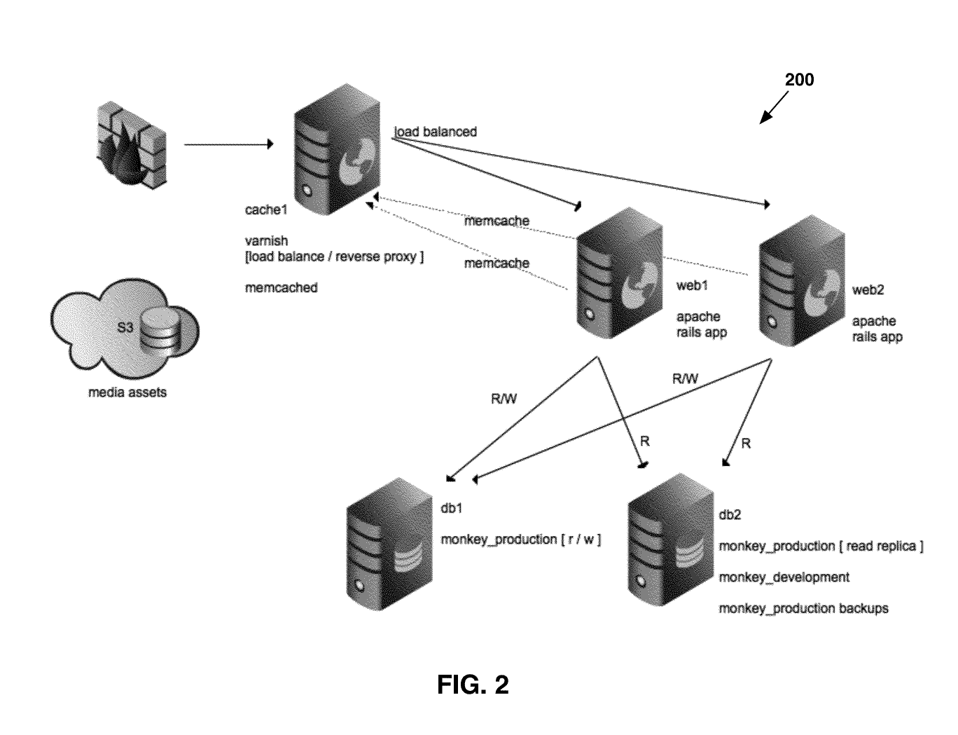

An example of system distributed servers and network architecture is shown in FIG. 2.

The business model and technology allow for multiple monetization strategies including recovery of a portion of the sales price (called breakage), subscriptions (for upgraded services), advertising and marketing services etc.

Technical Aspects

Subscription

People can join Monkeybars multiple ways, e.g.,:

(a) independently,

(b) in response to invitations initiated by existing Monkeybars members,

(c) in response to informal suggestions that may appear in email or social media, or

(d) as a result of purchasing or browsing an item recommended by someone

Genealogy

In some embodiments, when a user joins Monkeybars, the system will identify whether or not the person is joining in response to another member's suggestion, invitation or content (e.g., b-d above).

The existing member who originated the suggestion, invitation or content will be recorded as the parent of the new member, and the new member will form part of the existing member's network. Monkeybars' website applies tracking logic to determine which network is appropriate for the new member to join when invitations are not accepted but content is bought.

For example: When a person arrives at the Monkeybars website, the system will assess whether the person has visited the site in response to an invitation or shared content. This will allow the visitor to browse the site without disrupting where the visitor will fit in the genealogy should they elect to join. However, the system will permit visitors to assume other positions in the genealogy if they decide to purchase some content that is different to, and independent of, the reason for their initial visit. This will happen where, for instance, a person is invited to the site by member (A) but chooses to buy content from member (B) before joining In this situation, member (B) becomes the inviter.

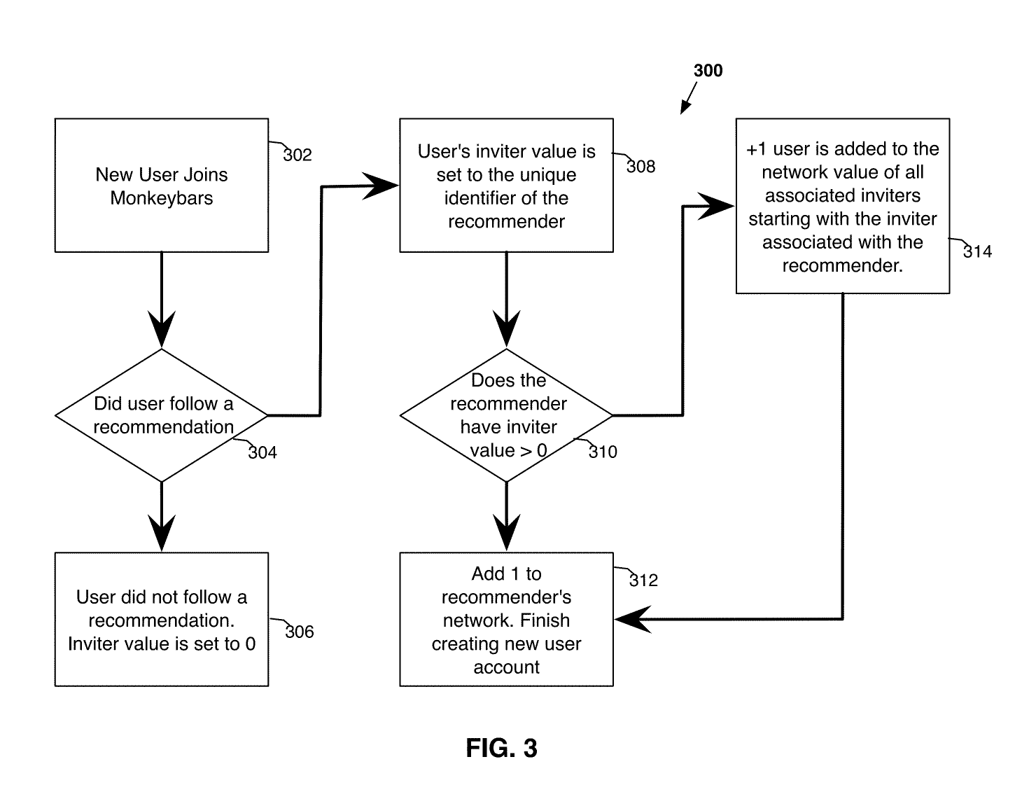

Referring to FIG. 3, an exemplary method of setting the genealogy and/or hierarchy of members may include using an “inviter value”. For example, when a new user joins 302, the system may check to determine if the user followed a recommendation 304, e.g., from another user recommending content. If not, the user value may be set to zero 306. If the new user was following a recommendation, then the users inviter value is associated with the recommender 308. The recommender inviter value is then assessed 310 and modified 312 based on the recommendation. Other associated inviters in the genealogy (e.g., users who previously invited, directly or indirectly, the inviter) each have their respective network values adjusted to reflect the new member of the hierarchy.

In such embodiments, this user network may be the basis for the commission structure used to reward sharing and recommendation via Monkeybars.

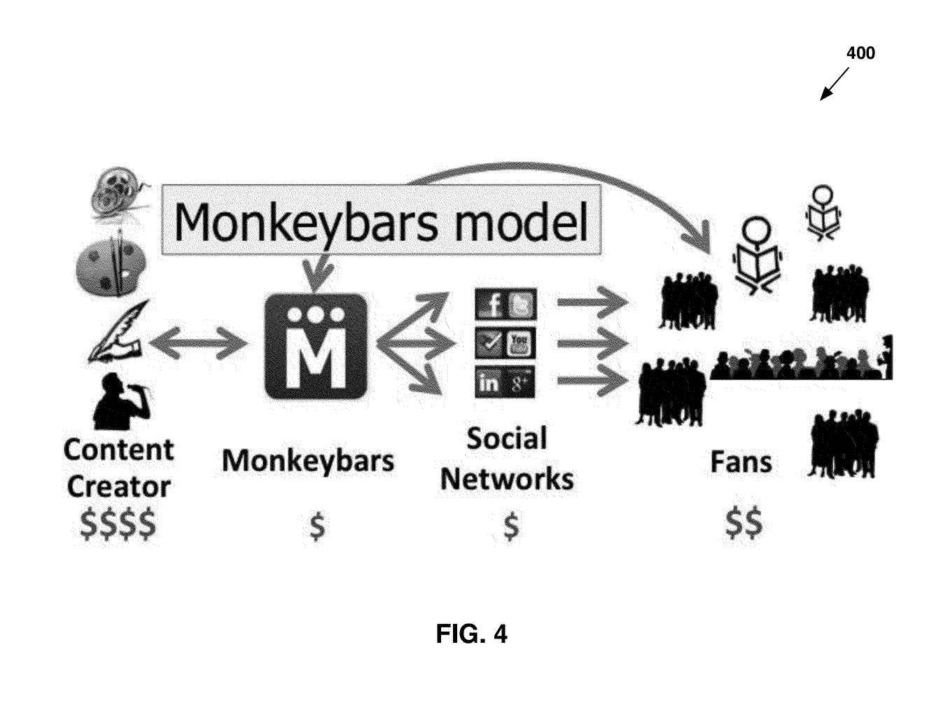

Referring to FIG. 4, in some embodiments the Monkeybars system facilitates the sale of content from content creators over social networks to fans of the content creators. As illustrated, money and/or savings are shared across the ecosystem, with content creators getting the most money and fans receiving a substantial savings, while recommenders within the social networks receive financial rewards for participating in the sale.

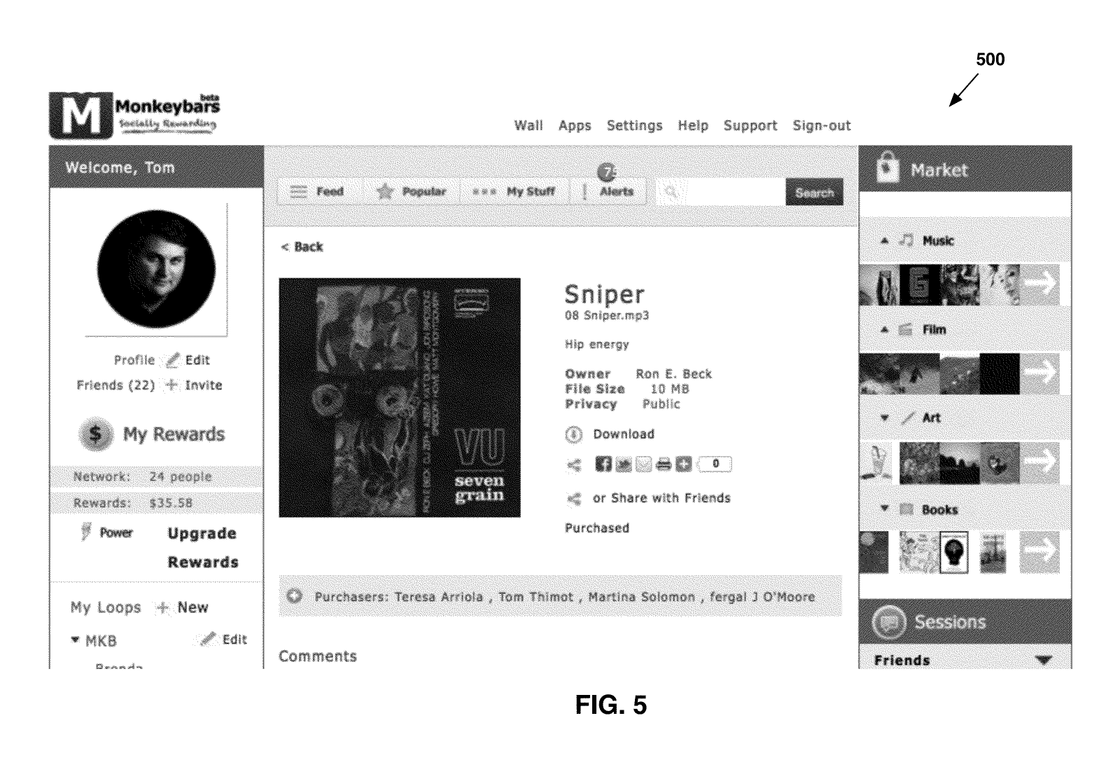

As shown in FIG. 5, a user interface screen 500 according to one embodiment may include information regarding the user's network and rewards earned using the system, windows for purchasing and/or sharing content, and links or fields for browsing or searching available content, e.g., in a market.

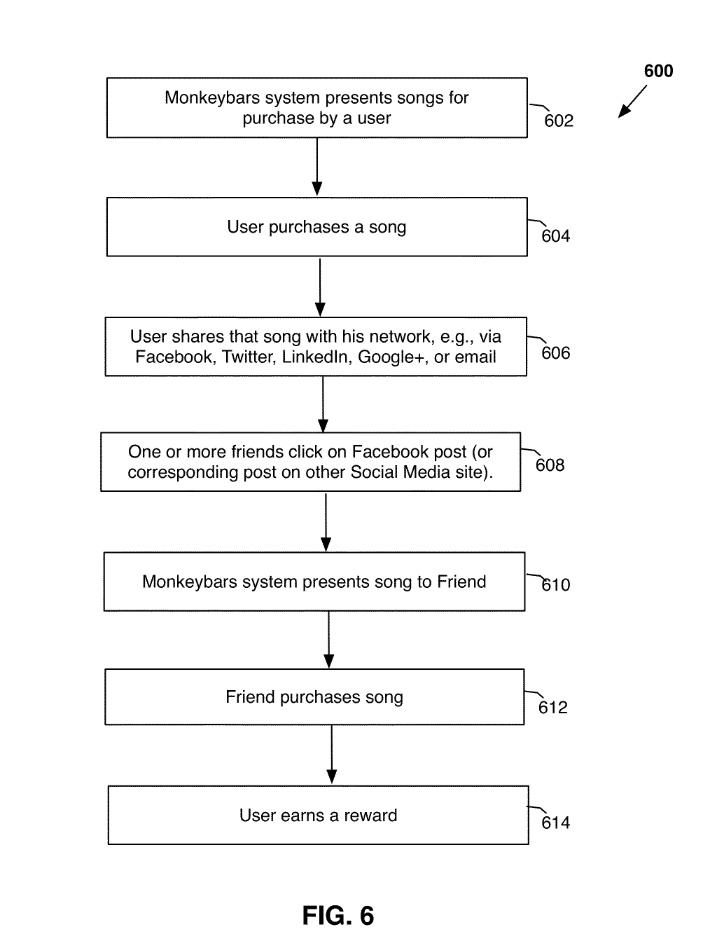

Referring to FIG. 6, a method 600 of rewarding a user for recommending content may include presenting content for purchase by the user 602, and selling and distributing purchased content to the user 604. A user may then share 606, or recommend, the purchased content to friends over social networks or other communication channels. When a friend follows a recommendation post 608, the system may present the content to the friend (e.g., via a user interface as shown in FIG. 5). If the friend purchases the content 612, the user who recommended the content earns a cash reward. In other embodiments, rewards may include credits, points, content, merchandise, or value.

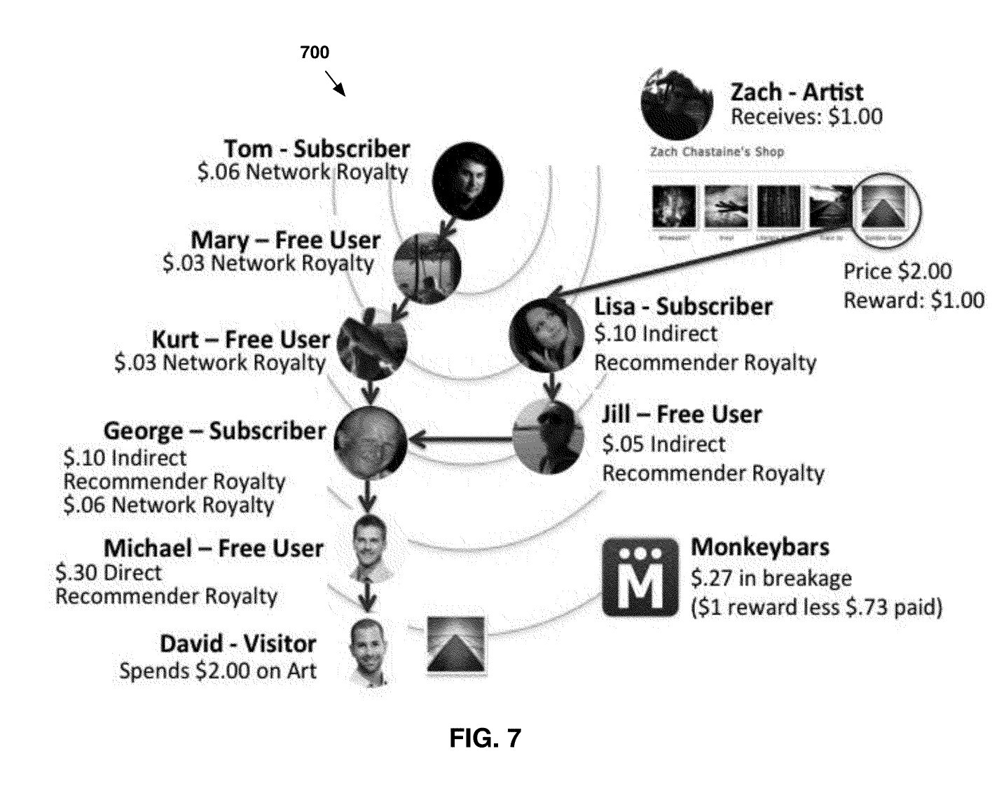

Turning to FIG. 7, an exemplary method 700 for providing monetary rewards to users is shown. In this example, different classes of hypothetical users are shown, including subscribers, free users, and visitors. The users share a reward value of $1.00 from a $2.00 purchase by a visitor. The amount each user receives may depend upon their level in the system and relationship to the recommender and/or chain of recommendation of the content, e.g., their commission or royalty is based upon their level of participation in the sale and rank in the hierarchy relative to the recommender.

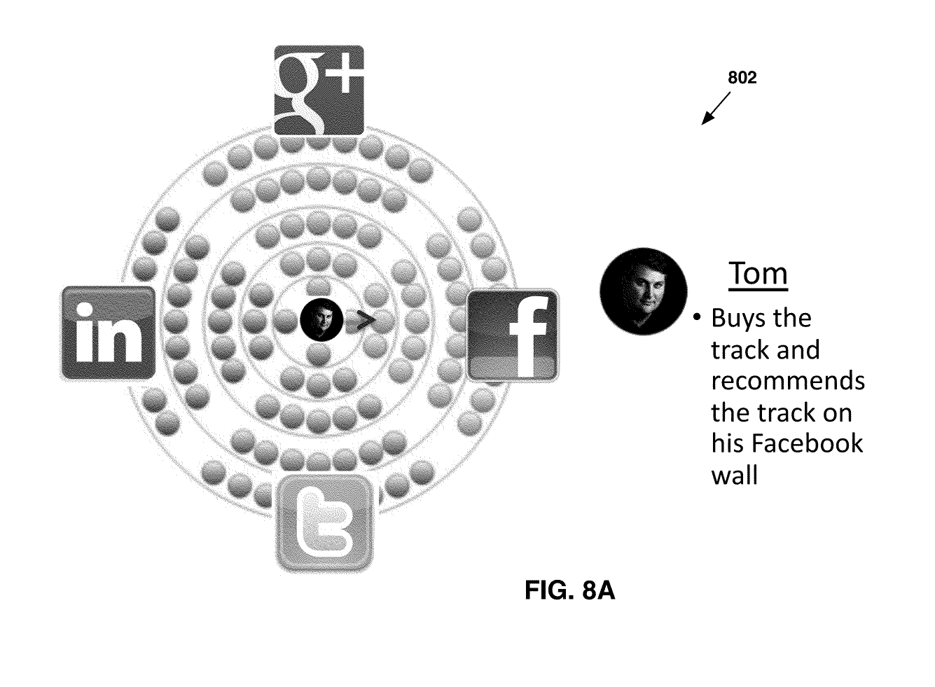

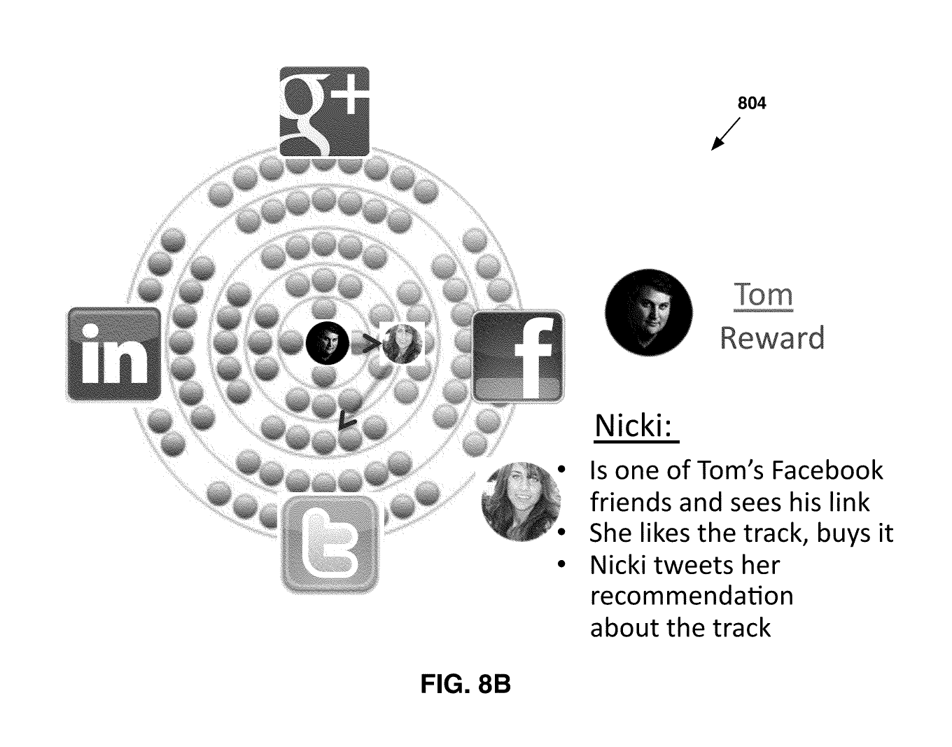

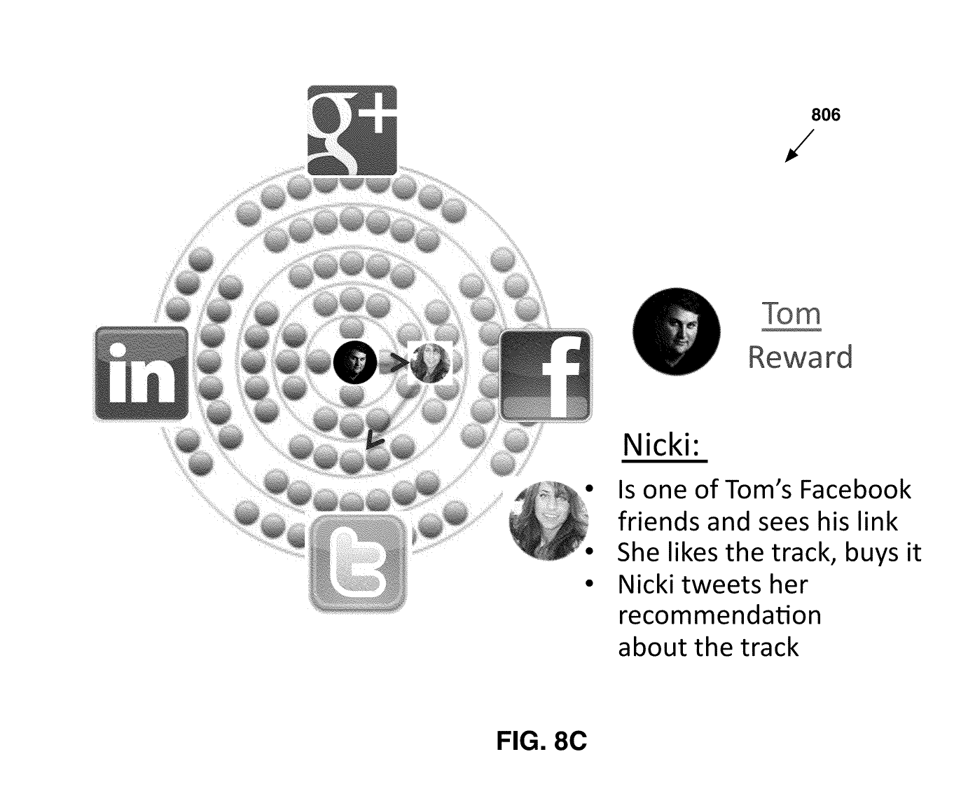

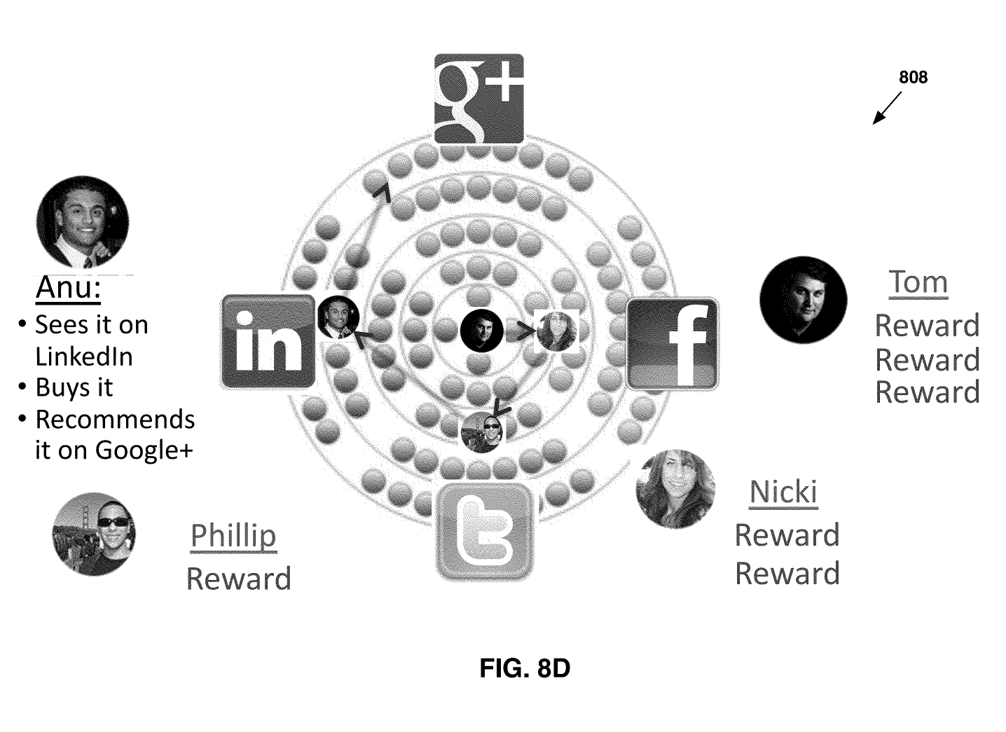

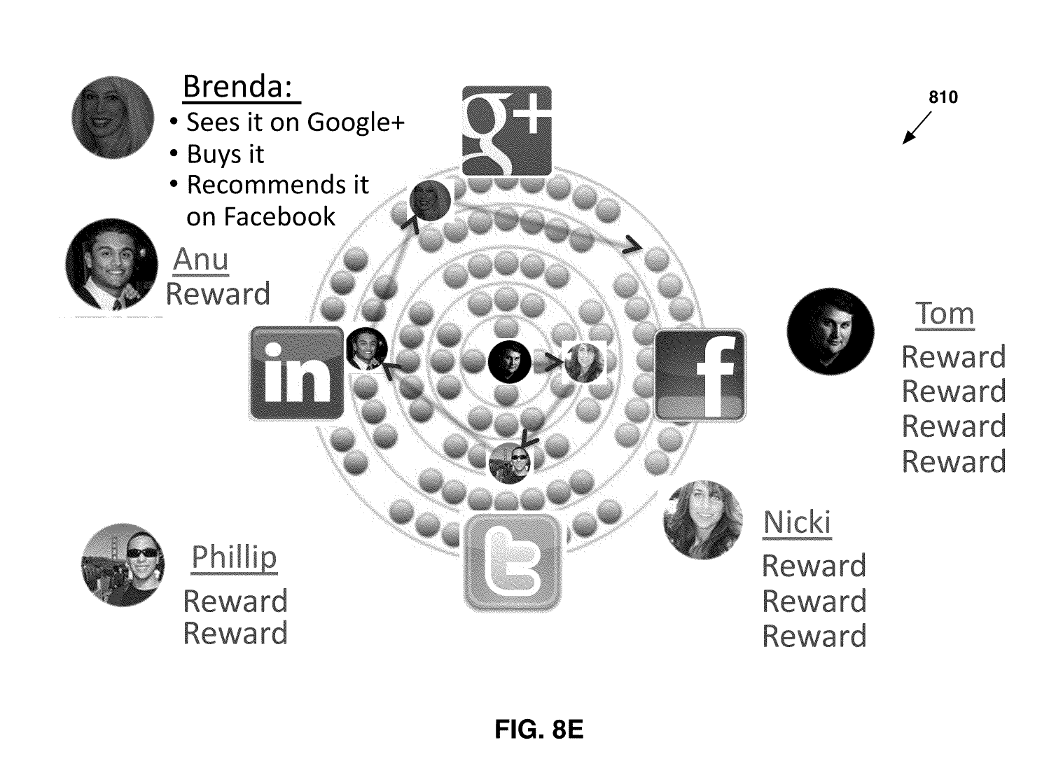

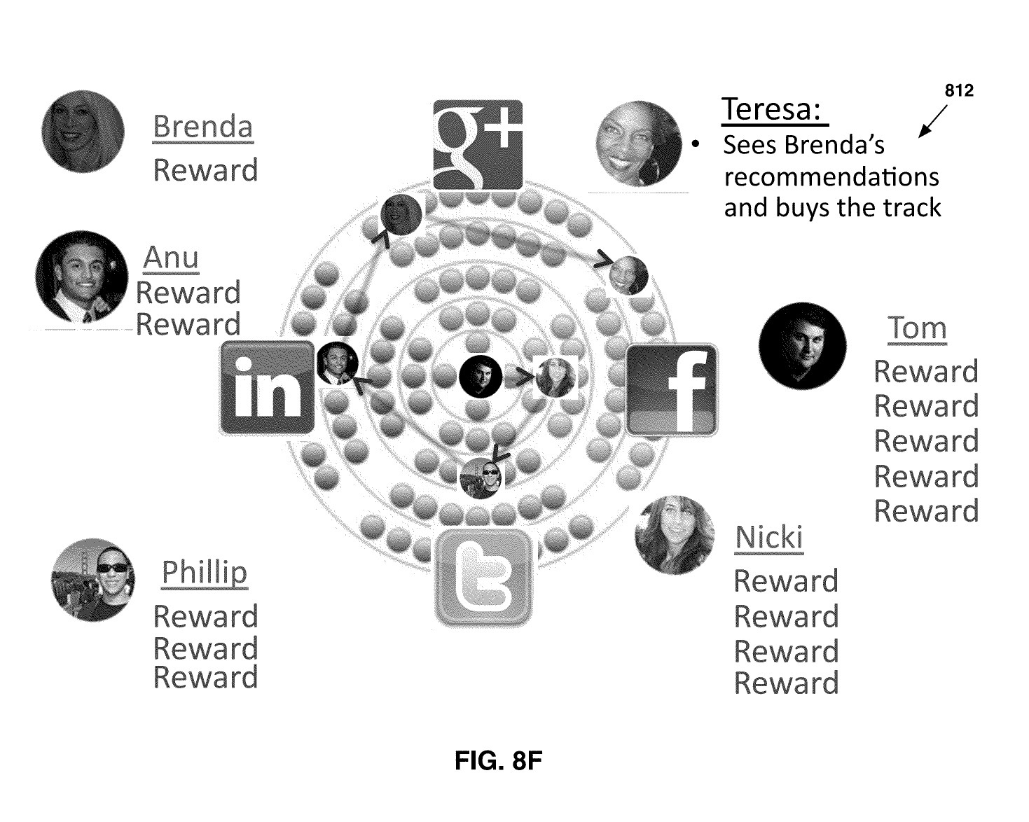

In another example, FIGS. 8A, 8B, 8C, 8D, 8E, and 8F show steps 802, 804, 806, 808, 810 and 812, respectively, of a method of rewarding users of the system across for recommending and participating in the sale of content across social networks.

Sharing Sellable Items

Whenever a sellable item is recommended, the URL identifying the item comprises an encrypted key that contains information about the item and who has shared the item.

For example: A sellable item with a unique identifier of 1000—when not Recommended—may be identified by the following encrypted key, which would be embedded in the URL for the item:

0a5c7eaff38c10570ff7405680114765

This key may be generated, for example, using AES encryption, using a randomly generated cypher key and input vector that is stored securely on Monkeybars for use during the decryption process that occurs when a visitor uses the link to access the sellable item.

The same item—when shared by a member with the identifier of 33—would be represented with an encrypted key of:

427753b513ded7b74314118831854cfd

This way, numerous people can recommend one item without confusion about who should be rewarded or any possibility of interference by people who are not part of the chain of recommendation.

Moreover, this method allows Monkeybars to embed a genealogy used for calculating rewards in the URL for the sellable item.

For example:

Consider that member 10, invited a person who became member 11, who then invited another person who became member 12.

Consider next that member 12 shared item 1000.

The encrypted key for the item would be:

d2d50292abc7e55b4749f85474b4bfba

Consequently, when a potential purchaser of the item arrives at Monkeybars using a URL with this key embedded, the system knows that the item is item 1000 and also that 3 levels of rewards must be paid starting with member 12, then member 11 and finally member 10.

This can be used to ‘freeze’ the network state at the time or sharing, but can also be calculated independently by Monkeybars when only the actual sharer is included in the key. This is a fallback that may be used, e.g., if the network has radically changed because of removal of members in response to abuse of terms and conditions.

Recommending Monkeybars

Invitations use the same encryption scheme as above.

Rewards

Rewards in response to a recommendation are calculated based on compensation plans stored in the Monkeybars system.

Compensation plans can be updated easily to accommodate changes in commission structures.

A typical compensation plan might be:

| | | |
|---|---|---|
| Level 1 | Basic User 30% | Subscribed User 30% |
| Level 2 | Basic User 5% | Subscribed User 10% |
| Level 3 | Basic User 5% | Subscribed User 10% |
| Level 4 | Basic User 5% | Subscribed User 10% |
| Level 5 | Basic User 5% | Subscribed User 10% |

Levels correspond to steps up the network described in the genealogy section above.

For example:

Earlier, we described how member 12 shared item 1000; Member 12 was invited by member 11; and Member 11 was invited by member 10.

If an item costs $20 and 50% of its sale price was allocated by the seller as network rewards, then the following would happen at sale time:

Level 1: account 12 would receive $3.00 commission

Level 2: account 11 would receive $1.00 commission (if account 11 was a paying subscriber)

Level 3: account 10 would receive $0.50 commission (if account 10 was a basic user)

Since the network was exhausted in 3 levels in this example, the remainder of the commission will remain with Monkeybars. Of course, other commission amounts may be used at each level as desired, and depending upon the status of the accounts and members.

In other embodiments, a member may acquire a bin, folder or the like from the system, e.g., purchased from the page of a content provider on the system, and place content within the bin. Such content may then be displayed, marketed or advertised on other social network sites or pages of the member, and that the member be compensated based on purchases by friends or other individuals within such social networks.

The foregoing description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method of compensating individuals for sales of digital content, comprising:
receiving request from a new member to join a system for distributing digital content having a plurality of members, each of the plurality of members having a member network;
determining a relationship of the new member to an existing member of the plurality of members;
adding the new member to the member network of the existing user;
assigning a hierarchy for the new user within the member network of the existing member; and,
when a user purchases an item of digital content from the system,
determining whether the new member recommended the item, and
compensating the new member and the existing based upon their relative hierarchies within the member network.
